(19) United States
(12) Patent Application Publication
(10) Pub. No.: US 2013/0036792 A1
(43) Pub. Date: Feb. 14, 2013

(54) GAS SENSOR APPARATUS AND CONCENTRATION MEASUREMENT METHOD

(71) Applicants: Masao TSUDUKI, Kagamihara-shi (JP); Tomohiro Tajima, Kasugai-shi (JP); Ginjirou Ito, Nagoya-shi (JP)

(72) Inventors: Masao TSUDUKI, Kagamihara-shi (JP); Tomohiro Tajima, Kasugai-shi (JP); Ginjirou Ito, Nagoya-shi (JP)

(73) Assignee: NGK SPARK PLUG CO., LTD., Nagoya-shi (JP)

(21) Appl. No.: 13/568,681

(22) Filed: Aug. 7, 2012

(30) Foreign Application Priority Data
Aug. 8, 2011 (JP) 2011-173073

(51) Int. Cl. G01M 15/04

(52) U.S. Cl. 73/23.21

(57) ABSTRACT

A gas sensor apparatus (1) includes a gas sensor (10) which outputs an output value corresponding to the concentration of a specific gas component contained in a gas; a pressure sensor (20) which measures the pressure of the gas; and a computation section (30) which computes a value representing the concentration of the specific gas component based on the output value from the gas sensor (10) and the pressure of the gas. The computation section (30) computes a concentration value using an expression derived from Fick's law and is a function of the output value and the pressure value, computes a correction value on the basis of a correction term which is a function of the provisional specific-component concentration and the pressure value, and corrects the provisional specific-component concentration using the correction value in order to compute the concentration value of the specific gas component.

### BACKGROUND OF THE INVENTION

1. Field of the Invention

The present invention relates to a gas sensor apparatus which includes a gas sensor for measuring the concentration of a gas to be detected, and to a concentration measurement method performed using the gas sensor. In particular, the subject apparatus and method of the invention are suitable for use in the case where a value output from the gas sensor must be corrected on the basis of pressure.

2. Description of the Related Art

For internal combustion engines such as a diesel engine and a gasoline engine, a common practice is to control a mixture ratio (i.e., a ratio of a gas to fuel which are supplied to the combustion chamber) in order to reduce fuel consumption and purify exhaust gas. In order to control the mixture ratio, a gas sensor is used to measure the proportion of a specific gas component (e.g., oxygen) contained in the intake gas or the proportion of the specific gas component contained in the exhaust gas.

The gas sensor includes a sensor element disposed in a gas (i.e., a target for measurement). The sensor element outputs a value representing the concentration of a specific gas component (e.g., oxygen concentration), which is the ratio of the specific gas component. However, the value output from the sensor element is known to be affected not only by the concentration of the specific gas component of the gas but also by the pressure of the gas.

In recent years, as precision control of an internal combustion engine has increased, there has been an increasing need for measuring the concentration of a specific gas component more accurately. In order to measure the concentration of a specific gas component of a gas (i.e., a target for measurement) more accurately, various methods have been proposed for eliminating the influence of gas pressure upon the value output from the gas sensor (see, for example, Patent Documents 1 and 2).

Patent Documents 1 and 2 disclose a configuration including a sensor element which measures the concentration of a specific gas component of a gas (i.e., a target for measurement) and a pressure sensor which measures the pressure of the gas. In addition, Patent Documents 1 and 2 propose a method (correction method) for eliminating the influence of the gas pressure on the value which is output from the gas sensor and represents the concentration of the specific gas component. In this method, the value output from the gas sensor is multiplied by a coefficient based on the pressure measured by the pressure sensor, whereby the influence of the gas pressure on the output value is negated.

[Patent Document 1] Japanese Patent Application Laid-Open (kokai) No. 6-273381

[Patent Document 2] Japanese Patent Application Laid-Open (kokai) No. 2005-061420

3. Problems to be Solved by the Invention

By using the correction method of the above-described Patent Documents 1 and 2, the accuracy of a value representing the concentration of a specific gas component can be improved as compared with the case where the value output from the gas sensor and representing the concentration of the specific gas component is not corrected. However, the need for yet more precise control of an internal combustion engine will continue to increase. As a result, there is an increasing need to obtain a value representing the concentration of the specific gas component more accurately. That is, the correction method of the above-described Patent Documents 1 and 2 has a problem in that the method encounters difficulty in obtaining a value which represents the concentration of the specific gas component with the required accuracy.

### SUMMARY OF THE INVENTION

The present invention has been made to solve the above-described problems, and an object thereof is to provide a gas sensor apparatus and a concentration measurement method using a gas sensor, which apparatus and method can improve the accuracy of a value which is obtained from an output value of the gas sensor and which represents the concentration of a specific gas component contained in a gas.

The above object of the present invention has been achieved by providing, in a first aspect, a gas sensor apparatus (1) which comprises a gas sensor which outputs an output value corresponding to the concentration of a specific gas component contained in a gas flowing through a flow passage provided in an internal combustion engine; a pressure sensor which measures the pressure of the gas; and a computation section which computes a concentration value of the specific gas component on the basis of the output value output from the gas sensor and a pressure value of the gas measured by the pressure sensor. The computation section computes a provisional specific-component concentration using an expression which is derived from Fick's law and is a function of the output value output from the gas sensor and the pressure value measured by the pressure sensor, computes a correction value on the basis of a correction term which is a function of the provisional specific-component concentration and the pressure value measured by the pressure sensor, and corrects the provisional specific-component concentration using the correction value in order to compute the concentration value of the specific gas component.

According to the gas sensor apparatus (1) of the present invention, since the value representing the concentration of the specific gas component (provisional specific-component concentration) is computed using an expression which is derived from Fick's law and is a function of the output value from the gas sensor and the pressure value measured by the pressure sensor, the accuracy of the value representing the concentration of the specific gas component can be improved as compared with the case where the value output from the gas sensor and representing the concentration of the specific gas component is not corrected.

In addition, according to the gas sensor apparatus of the present invention, even if the provisional specific-component concentration computed on the basis of Fick's law contains an error, the error of the corrected concentration value of the specific gas component can be decreased by correcting the provisional specific-component concentration using a correction value based on a correction term which is a function of the provisional specific-component concentration and the pressure value measured by the pressure sensor.

The present inventors empirically found that the provisional specific-component concentration computed using the expression derived from Fick's law still depends on the concentration of a specific gas component and the gas pressure. That is, the present inventors found that, when the concentration of a specific gas component is measured for two gases each having the same concentration but differing in gas pressure, a difference (error) arises between the provisional specific-component concentrations computed for each of these gases. In view of the above, a gas-pressure-attributable variation is removed from the provisional specific-component concentration by correcting the provisional specific-component concentration using a correction value calculated from a correction term which is a function of the provisional specific-component concentration and the pressure. Thus, the concentration value which represents the concentration of the specific gas component and which has a reduced error can be obtained. Notably, a preferred method of correcting the provisional specific-component concentration using the correction value is adding the correction value to the provisional specific-component concentration or subtracting the correction value from the provisional specific-component concentration.

Notably, the gas sensor apparatus of the present invention may be used to measure the concentration of a specific gas component contained in the intake gas or the exhaust gas flowing through the flow passage provided in the internal combustion engine; however, preferably, the gas sensor apparatus of the present invention is used to measure the concentration of a specific gas component contained in the intake gas. Since the pressure of the intake gas changes greatly, the output value from the gas sensor and the concentration value of the specific gas component are more likely to contain errors. By using the gas sensor apparatus of the present invention, even when the concentration of a specific gas component contained in the intake gas is measured, a gas-pressure-attributable variation can be removed from the output value of the gas sensor, and the concentration value which represents the concentration of the specific gas component and which has a reduced error can be obtained.

In a preferred embodiment (2) of the above gas sensor apparatus (1) of the invention, the computation section computes the provisional specific-component concentration using the following expression:

$$Provisional specific \text{-} component concentration = 1 - {e}^{( - A \cdot {I}_{P} \cdot \frac{B + P}{P} )}$$

where Ip represents the output value output from the gas sensor, P represents the pressure value measured by the pressure sensor, and A and B are constants which allow approximation between two provisional specific-component concentrations which are computed from two pressure values and two output values corresponding to the two pressure values.

As mentioned above, since the provisional specific-component concentration is computed using the expression given above, the accuracy of the value representing the concentration of the specific gas component can be improved as compared with the case where the value output from the gas sensor and representing the concentration of the specific gas component is not corrected. Moreover, although the provisional specific-component concentration computed using the expression given above contains an error, the error of the corrected concentration value of the specific gas component can be decreased by correcting the provisional specific-component concentration using a correction value based on the correction term which is a function of the provisional specific-component concentration and the pressure value measured by the pressure sensor.

In another preferred embodiment (3) of the above gas sensor apparatus (1) or (2) of the invention, the correction term is a polynomial expression associated with the pressure measured by the pressure sensor.

Thus, the error of the concentration value of the specific gas component computed by the computation section can be decreased by using, as the correction term, a polynomial expression associated with the measured pressure. For example, even when the dependence of the provisional specific-component concentration on the gas pressure changes continuously with the change in gas pressure, an increase in the error of the concentration value of the specific gas component can be restrained by using, as the correction term, a polynomial expression selected for said change.

In yet another preferred embodiment (4) of the above gas sensor apparatus (3) of the invention, different coefficients are contained in individual terms of the polynomial expression, and preferably, each of these coefficients is a function of the provisional specific-component concentration.

Thus, since each of the coefficients of the individual terms of the correction term is a function of the provisional specific-component concentration, the error of the concentration value of the specific gas component and computed by the computation section can be decreased further. For example, in the case where the dependence of the provisional specific-component concentration on the gas pressure changes greatly with the gas pressure and the provisional specific-component concentration cannot be corrected satisfactorily through use of the correction term which is a fixed polynomial expression, decreasing the error of the concentration value of the specific gas component is difficult. Even in such a case, by changing the coefficients of the individual terms of the polynomial expression in accordance with the provisional specific-component concentration, the range in which the provisional specific-component concentration can be corrected by the correction term can be broadened and the increase in error of the concentration value of the specific gas component can be restrained more reliably.

In a second aspect (5), the present invention provides a concentration measurement method using a gas sensor disposed in a flow passage provided in an internal combustion engine which outputs an output value corresponding to the concentration of a specific gas component contained in a gas flowing through the flow passage, and a pressure sensor disposed in the flow passage which measures the pressure of the gas. The method computes a concentration value of the specific gas component on the basis of the output value output from the gas sensor and the pressure value of the gas measured by the pressure sensor. The method comprises the steps of computing a provisional specific-component concentration using an expression which is derived from Fick's law and which is a function of the output value from the gas sensor and the pressure value measured by the pressure sensor, computing a correction value on the basis of the provisional specific-component concentration and the pressure value measured by the pressure sensor, and correcting the provisional specific-component concentration using the correction value in order to compute the concentration value of the specific gas component.

According to the concentration measurement method of the present invention, since the value representing the concentration of the specific gas component (provisional specific-component concentration) is computed using the expression which is derived from Fick's law and is a function of the output value from the gas sensor and the pressure value measured by the pressure sensor, the accuracy of the value representing the concentration of the specific gas component can be improved as compared with the case where the value output from the gas sensor and representing the concentration of the specific gas component is not corrected.

Moreover, according to the concentration measurement method of the present invention, even if the provisional specific-component concentration computed on the basis of Fick's law contains an error, the error of the corrected concentration value of the specific gas component can be decreased by correcting the provisional specific-component concentration using a correction value based on the correction term which is a function of the provisional specific-component concentration and the pressure value measured by the pressure sensor.

In a preferred embodiment (6) of the above concentration measurement method (5) of the invention, the provisional specific-component concentration is computed using the following expression:

$$Provisional specific \text{-} component concentration = 1 - {e}^{( - A \cdot {I}_{P} \cdot \frac{B + P}{P} )}$$

where Ip represents the output value output from the gas sensor, P represents the pressure value measured by the pressure sensor, and A and B are constants which allow approximation between two provisional specific-component concentrations which are computed from two pressure values and two output values corresponding to the two pressure values.

As mentioned above, since the provisional specific-component concentration is computed using the expression given above, the accuracy of the value representing the concentration of the specific gas component can be improved as compared with the case where the value output from the gas sensor and representing the concentration of the specific gas component is not corrected. Moreover, although the provisional specific-component concentration computed using the expression given above contains an error, the error of the corrected concentration value of the specific gas component can be decreased by correcting the provisional specific-component concentration using a correction value based on the correction term which is a function of the provisional specific-component concentration and the pressure value measured by the pressure sensor.

In a preferred embodiment (7) of the above concentration measurement method (5) of the invention, the correction term is a polynomial expression associated with the pressure measured by the pressure sensor.

Thus, the error of the concentration value of the specific gas component computed by the computation section can be decreased by using, as the correction term, a polynomial expression associated with the measured pressure. For example, even when the dependence of the provisional specific-component concentration on the gas pressure changes continuously with the change in the gas pressure, an increase in the error of the concentration value of the specific gas component can be restrained by using, as the correction term, a polynomial expression selected for said change.

In yet another preferred embodiment (8) of the above concentration measurement method (7) of the invention, different coefficients are contained in individual terms of the polynomial expression, and preferably, each of these coefficients is a function of the provisional specific-component concentration.

Thus, since each of the coefficients of the individual terms of the correction term is a function of the provisional specific-component concentration, the error of the concentration value of the specific gas component and computed by the computation section can be decreased further. For example, in the case where the dependence of the provisional specific-component concentration on the gas pressure changes greatly with the gas pressure and the provisional specific-component concentration cannot be corrected satisfactorily through use of the correction term which is a fixed polynomial expression, decreasing the error of the value representing the concentration of the specific gas component is difficult. Even in such a case, by changing the coefficients of the individual terms of the polynomial expression in accordance with the provisional specific-component concentration, the range in which the provisional specific-component concentration can be corrected by the correction term can be broadened and the increase in the error of the concentration value of the specific gas component can be restrained more reliably.

### Effects of the Invention

The gas sensor apparatus according to the present invention and the concentration measurement method performed using the gas sensor according to the present invention can improve the accuracy of the value obtained from the output value of the gas sensor and which represents the concentration of a specific gas component contained in a gas.

### BRIEF DESCRIPTION OF THE DRAWINGS

FIG. 1 is a schematic diagram showing the configuration of a gas sensor apparatus according to one embodiment of the present invention.

FIG. 2 is a flowchart representing an oxygen concentration computation method performed by the ECU shown in FIG. 1.

FIGS. 3A-3C are graphs showing the coefficients a, b and c of a calculation formula for computing the coefficient C of a correction term.

FIGS. 4A and 4B are graphs showing the coefficients d and e of another calculation formula for computing the coefficient C of the correction term.

FIG. 5 is a graph showing the measurement error of the oxygen concentration measured by the gas sensor apparatus.

### DESCRIPTION OF REFERENCE NUMERALS

Reference numerals used to identify various structural features in the drawings include the following.

1: gas sensor apparatus

10: oxygen sensor (gas sensor)

20: pressure sensor

30: engine control unit (computation section)

40: internal combustion engine

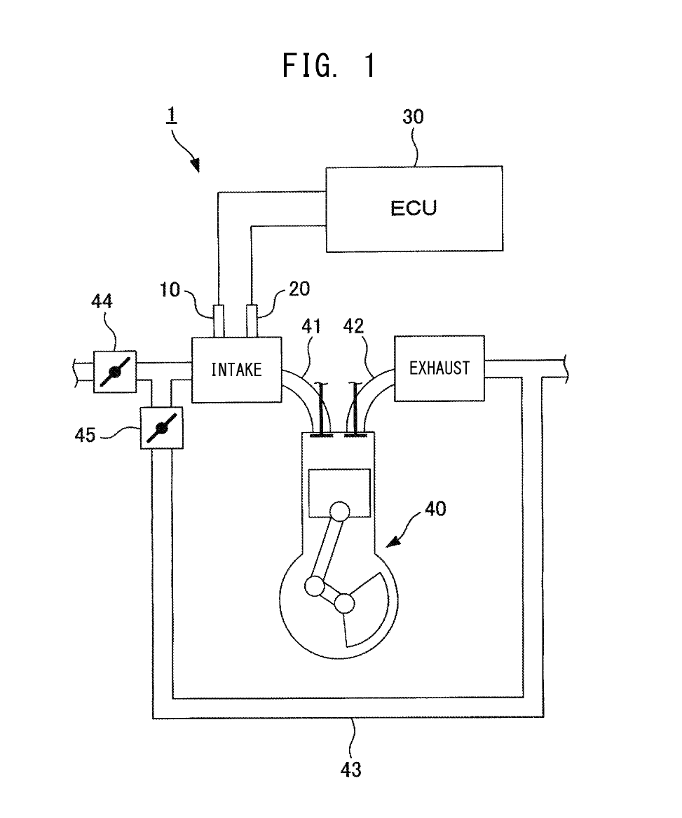

A gas sensor apparatus 1 according to one embodiment of the present invention will now be described with reference to FIGS. 1 to 5. However, the present invention should not be construed as being limited thereto.

FIG. 1 is a schematic diagram showing the configuration of the gas sensor apparatus 1 according to the present embodiment.

As shown in FIG. 1, the gas sensor apparatus 1 measures the concentration of oxygen contained in the intake gas which is taken into an internal combustion engine 40. The oxygen concentration measured by the gas sensor apparatus 1 is used to control the internal combustion engine 40; for example, it is used to control an air-fuel ratio. The gas sensor apparatus 1 is mainly composed of an oxygen sensor (gas sensor) 10, a pressure sensor 20, and an engine control unit (computation section) 30 (hereinafter referred to as an “ECU 30”).

Notably, in the present embodiment, the gas sensor apparatus 1 of the present invention is used to measure the concentration of oxygen contained in the intake gas which is taken into the internal combustion engine 40. However, the gas sensor apparatus 1 of the present invention may be used to measure the concentration of oxygen contained in the exhaust gas which is discharged from the internal combustion engine 40, and no particular limitation is imposed on the gas for which oxygen concentration is measured. However, use of the gas sensor apparatus of the present invention is effective for measuring the concentration of oxygen contained in the intake gas. This is because the pressure of the intake gas changes greatly, and the O₂ concentration and the output value of a sensor element, which will be described below, are more likely to involve errors.

The oxygen sensor 10 and the pressure sensor 20 are disposed in an intake pipe 41 of the internal combustion engine 40. Specifically, the oxygen sensor 10 and the pressure sensor 20 are disposed on the internal combustion engine 40 side in relation to a junction point where the intake pipe 41 and an exhaust gas recirculation pipe 43 (hereinafter referred to as an “EGR pipe 43”) are connected together; namely, these sensors are disposed downstream of the junction point. Meanwhile, an intake valve 44 for controlling the flow rate of air flowing through the intake pipe 41 is disposed in the intake passage 41 at a position upstream of the positions at which the oxygen sensor 10 and the pressure sensor 20 are disposed therein. Notably, no particular limitation is imposed on the relative positions of the oxygen sensor 10 and the pressure sensor 20; that is, the oxygen sensor 10 may be disposed upstream of the pressure sensor 20, or the pressure sensor 20 may be disposed upstream of the oxygen sensor 10.

Notably, the EGR pipe 43 connects an exhaust pipe 42 and the intake pipe 41 so as to lead a portion of the exhaust gas flowing through the exhaust pipe 42 to the intake pipe 41; namely, the EGR pipe 43 is provided to recirculate the exhaust gas. The EGR pipe 43 has a control valve 45 for controlling the recirculation amount of the exhaust gas.

The oxygen sensor 10 measures the concentration of oxygen contained in the intake gas flowing through the intake pipe 41, and outputs a current Ip which is an output value representing the oxygen concentration. The value of the current Ip changes with the concentration of oxygen contained in the intake gas as well as the pressure of the intake gas flowing through the intake pipe 41. In other words, the current Ip is a function of the oxygen concentration, and is also a function of the pressure of the intake gas. Notably, no particular limitation is imposed on the type, etc., of the oxygen sensor 10, so long as it is a commonly-known sensor having the above-described characteristic.

The pressure sensor 20 measures the pressure of the intake gas flowing through the intake pipe 41 so as to output a measurement signal corresponding to the pressure of the intake gas. Notably, a commonly-known pressure sensor may be used as the pressure sensor 20; that is, no particular limitation is imposed on the type, etc. of the pressure sensor 20.

The ECU 30 obtains, through computation, the oxygen concentration of the intake gas flowing through the intake pipe 41 on the basis of the output value from the oxygen sensor 10 and the pressure value measured by the pressure sensor 20. The ECU 30 controls the operation state of the internal combustion engine 40 based on at least the oxygen concentration thus obtained. An oxygen concentration computation method performed by the ECU 30 will be described below.

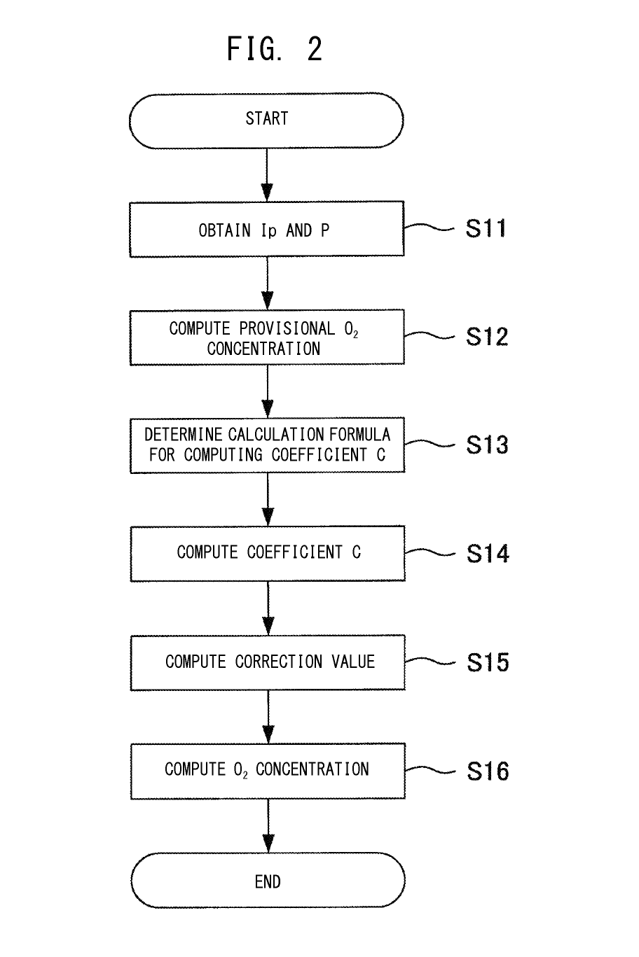

Next, an oxygen concentration computation method performed in the gas sensor apparatus 1 configured as mentioned above will be described. FIG. 2 is a flowchart representing the oxygen concentration computation method performed by the ECU 30 shown in FIG. 1.

First, the ECU 30 executes a step (S11) of receiving the output value (current Ip) from the oxygen sensor 10 and a pressure-related electric signal which is a measurement signal output from the pressure sensor 20. The pressure-related electric signal is converted to the pressure value P of the intake gas flowing through the intake pipe 41 with reference to a table, etc., which is pre-stored in the ECU 30.

Next, the ECU 30 executes a step (S12) of computing a provisional O₂ concentration (corresponding to a “provisional specific-component concentration” of the invention) through use of Expression (1) given below. The provisional O₂ concentration is a value which represents the oxygen concentration and which can be obtained by substituting the value of the current Ip and the pressure value P of the intake gas into Expression (1) derived from Fick's law.

$$Provisional {O}_{2} concentration = 1 - {e}^{( - A \cdot {I}_{P} \cdot \frac{B + P}{P} )} \qquad ( 1 )$$

In Expression (1), Ip is the output value from the oxygen sensor 10, and P is the pressure value measured by the pressure sensor 20. Notably, A and B are constants determined such that two provisional specific-component concentrations computed for two pressure values approximate each other. Specifically, A is a constant determined by Expression (2) given below, and B is a constant determined by Expression (3) given below.

$$\begin{matrix}A = \frac{LR}{4 {SFkT}^{0.75}} & ( 2 ) \\ B = \frac{k}{{k}^{′}} {T}^{1.25} & ( 3 )\end{matrix}$$

In Expressions (2) and (3), L is the length (m) of a diffusion hole of the oxygen sensor 10; R is the gas constant (8.314 JK⁻¹mol⁻¹); S is the cross-sectional area (m²) of the diffusion hole of the oxygen sensor 10; F is the Faraday constant (9.6485×10⁴ Cmol⁻¹); and T is the temperature (K) of the gas passing through the diffusion hole of the oxygen sensor 10.

Notably, no particular limitation is imposed on the method of obtaining the above-described coefficients A and B. That is, the above-described coefficients A and B may be respectively calculated from the above-described Expressions (2) and (3), or they may be empirically obtained by measuring the oxygen concentration of a gas whose O₂ concentration and pressure are known.

The above-described Expression (1) is obtained as follows. Expression (5) is derived from Expression (4) (i.e., Fick's law) given below. Expression (6) representing a diffusion coefficient D_{AB}, which is obtained by combining a molecular diffusion coefficient Dₘ (=kT^{1.75}/P) and a Knudsen diffusion coefficient Dk (=k′T^{0.5}), is substituted into Expression (5), from which Expression (7) is obtained through rearrangement. Expression (1) is obtained from Expression (7).

$$\begin{matrix}{\dot{c}}_{A} - {w}_{A} \dot{c} = - {cD}_{AB} \frac{\partial {w}_{A}}{\partial y} & ( 4 ) \\ I = - \frac{4 {SFD}_{AB} P}{LRT} ln ( 1 - \frac{{P}_{A}}{P} ) & ( 5 )\end{matrix}$$

In Expressions (4) and (5), c_{A} over which a dot (•) is placed is the molar mass velocity (=c_{A}v_{A}) of a component A; w_{A} is the mole fraction (=c_{A}/c) of the component A; c over which a dot (•) is placed is the molar mass velocity (=cv); and c is the molar concentration (kmol/m³). Meanwhile, P_{A} is the partial pressure (kPₐ) of the component A; P is the pressure (kPa) of the gas; and P_{A}/P is the concentration (%) of the component A.

$$\begin{matrix}\frac{1}{{D}_{AB}} = \frac{1}{{D}_{m}} + \frac{1}{{D}_{k}} \\ {D}_{AB} = \frac{{kk}^{′} {T}^{2.25}}{{kT}^{1.75} + {k}^{′} {T}^{0.5} P} & ( 6 ) \\ I = - \frac{4 SFP}{LRT} \frac{{kk}^{′} {T}^{2.25}}{{kT}^{1.75} + {k}^{′} {T}^{0.5} P} ln ( 1 - \frac{{P}_{A}}{P} ) \\ ln ( 1 - \frac{{P}_{A}}{P} ) = A \cdot I \cdot \frac{B + P}{P} \\ \frac{{P}_{A}}{P} = 1 - {e}^{( - A \cdot I \cdot \frac{B + P}{P} )} & ( 7 )\end{matrix}$$

After computing the provisional O₂ concentration, the ECU 30 executes a step (S13) of determining a calculation formula for computing a coefficient C. The coefficient C is contained in the correction term of Expression (8) (given below) which is used to obtain the O₂ concentration (corresponding to the “concentration value” of the invention) from the provisional O₂ concentration (see Expression (9)).

O₂ concentration=Provisional O₂ concentration−Correction term (8)

Correction term=Provisional O₂ concentration·(C/100) (9)

The coefficient C is computed using a calculation formula which is selected in accordance with the intake gas pressure measured by the pressure sensor 20. In the present embodiment, Expression (10) given below is selected as a calculation formula when the measured intake gas pressure is lower than a predetermined pressure value P_{T}, and Expression (11) given below is selected as a calculation formula when the measured intake gas pressure is equal to or higher than the predetermined pressure value P_{T}.

C=ax²+bx+c (10)

C=dx+e (11)

In Expressions (10) and (11), x is the intake gas pressure measured by the pressure sensor 20.

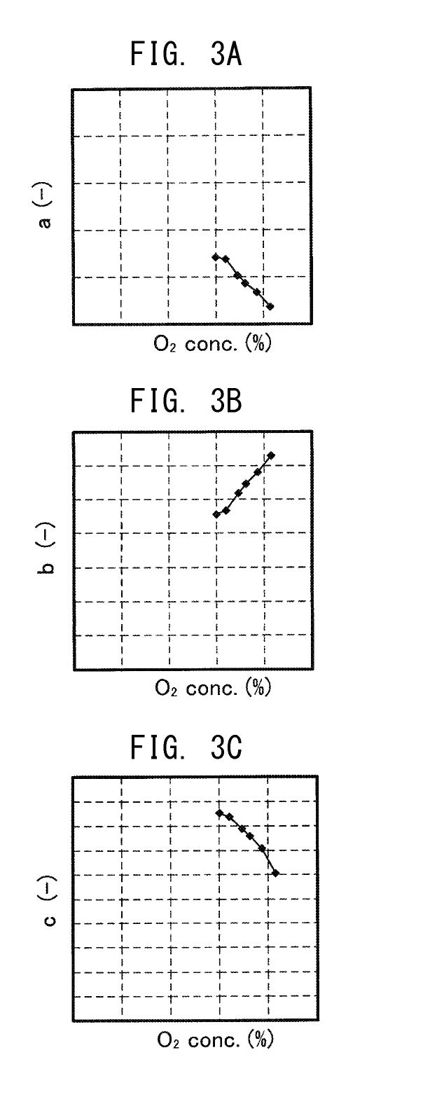

a is a coefficient determined on the basis of the value of the provisional O₂ concentration. Specifically, as shown in FIG. 3A, a is a coefficient that decreases as the value of the provisional O₂ concentration increases. b is a coefficient determined on the basis of the value of the provisional O₂ concentration. Specifically, as shown in FIG. 3B, b is a coefficient that increases with the value of the provisional O₂ concentration. c is a coefficient determined on the basis of the provisional O₂ concentration. Specifically, as shown in FIG. 3C, c is a coefficient that decreases as the value of the provisional O₂ concentration increases.

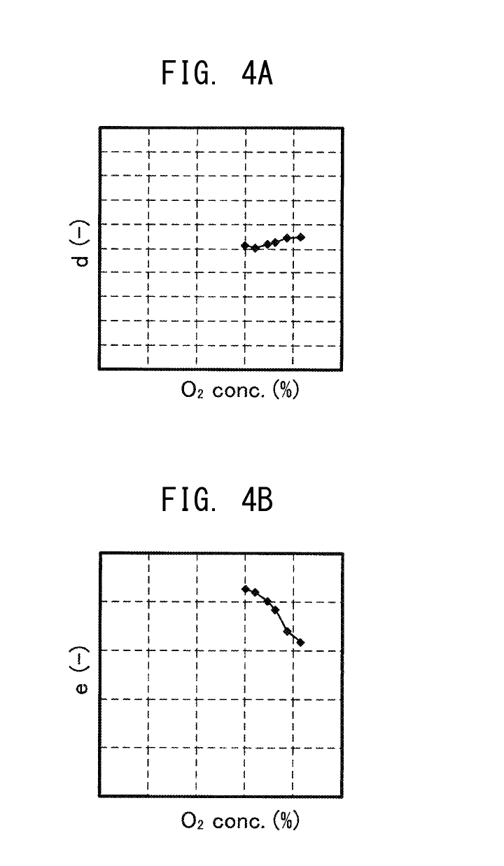

d is a coefficient determined on the basis of the value of the provisional O₂ concentration. Specifically, as shown in FIG. 4A, d is a coefficient that changes with the value of the provisional O₂ concentration. e is a coefficient determined on the basis of the value of the provisional O₂ concentration. Specifically, as shown in FIG. 4B, e is a coefficient that decreases as the value of the provisional O₂ concentration increases.

After selecting the calculation formula for computing the coefficient C, the ECU 30 executes a step (S14) of computing the coefficient C.

For example, when the intake gas pressure measured by the pressure sensor 20 is lower than the pressure value P_{T}, the ECU 30 selects the above-described expression (10) as a calculation formula, and computes the value of the coefficient C on the basis of the values of the coefficients a, b, and c which correspond to the computed provisional O₂ concentration and the intake gas pressure measured by the pressure sensor 20.

After computing the value of the coefficient C, the ECU 30 executes a step (S15) of computing a correction value which is a value of the correction term. Specifically, the ECU 30 computes the value of the correction term on the basis of the above-described Expression (9), the computed provisional O₂ concentration, and the value of the coefficient C computed in S14.

Subsequently, the ECU 30 executes a step (S16) of computing an O₂ concentration (concentration value) on the basis of the above-described Expression (8), the computed provisional O₂ concentration, and the value of the correction term computed in Step S15. Thus, computation of the oxygen concentration by the gas sensor apparatus 1 is completed.

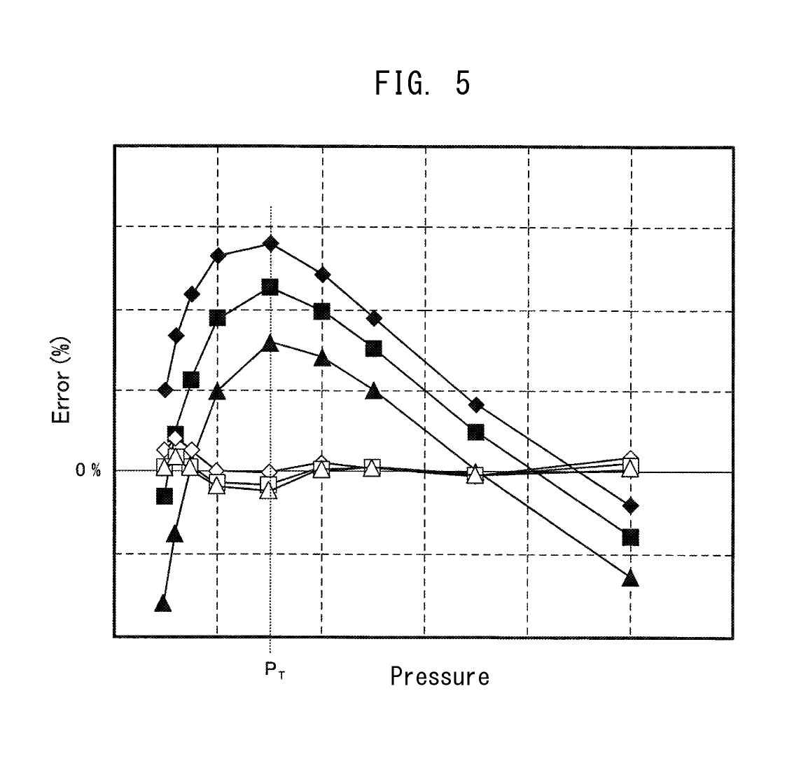

Next, the measurement error (measurement accuracy) of the oxygen concentration measured by the gas sensor apparatus 1 of the present embodiment will now be described, with reference to FIG. 5, as contrasted with the measurement error of the oxygen concentration (corresponding to the provisional O₂ concentration of the present embodiment) measured by a conventional measurement method.

In FIG. 5, the vertical axis represents the degree of the oxygen concentration measurement error, and the horizontal axis represents the pressure of the intake gas which is the target for measurement. Measurement results obtained when the concentration of oxygen contained in the intake gas (target for measurement) was 15% are represented by respective curves connecting rhombuses (♦ and ⋄); the measurement results obtained when the concentration of oxygen contained in the intake gas (target for measurement) was 18% are represented by respective curves connecting squares (▪ and □); and measurement results obtained when the concentration of oxygen contained in the intake gas (target for measurement) was 21% are represented by respective curves connecting triangles (▴ and Δ). In addition, errors in the results of measurements performed by the gas sensor apparatus 1 of the present embodiment are represented by curves connecting white rhombuses (⋄), white squares (□), and white triangles (Δ), respectively; and errors in the results of measurements performed by the conventional method are represented by curves connecting black (filled) rhombuses (♦), black squares (▪), and black triangles (▴), respectively.

First, the influence of the pressure of the intake gas (target for measurement) on the degree of measurement error will be described.

In the case where the oxygen concentration is measured by the conventional measurement method, the degree of measurement error changes greatly with the change in gas pressure at all oxygen concentrations (in the case of ♦, ▪, and ▴). Specifically, in a pressure range where the gas pressure is lower than the predetermined pressure value P_{T}, the degree of measurement error increases with the gas pressure, and in a range where the gas pressure is equal to or higher than the pressure value P_{T}, the degree of measurement error decreases as the gas pressure increases.

Notably, the predetermined pressure value P_{T} described herein is the same as that used in the above-described step S13. In other words, the calculation formula used for computing the coefficient C is selected according to how the provisional O₂ concentration changes with the intake gas pressure.

In contrast, in the case where the oxygen concentration is measured by the gas sensor apparatus 1 of the present embodiment, the degree of error changes in a relatively narrow range at all oxygen concentrations (in the case of ⋄, □, and Δ) regardless of the change in intake gas pressure. In other words, the gas sensor apparatus 1 of the present embodiment can measure the oxygen concentration with an error in a narrow error range, without being influenced by the change in intake gas pressure.

Next, the influence of the oxygen concentration of the intake gas (target for measurement) on the measurement error will be described.

When the conventional measurement method is used, the degree of measurement error changes greatly with the change in oxygen concentration. Specifically, the degree of measurement error decreases as the oxygen concentration increases (♦→▪→▴). In contrast, when the gas sensor apparatus 1 of the present embodiment is used, the degree of measurement error changes with the change in oxygen concentration but the change in the degree of measurement error is obviously small.

As seen from the above, the measurement error of the oxygen concentration measured by the gas sensor apparatus 1 of the present embodiment is less likely to be affected by the pressure and oxygen concentration of the intake gas (target for measurement), as compared with the measurement error of the oxygen concentration measured by the conventional measurement method.

According to the above-described configuration, even if the provisional O₂ concentration computed using Expression (1) derived from Fick's law contains an error, the provisional O₂ concentration can be corrected using the correction value based on the correction term which is a function of the provisional O₂ concentration and the pressure value P measured by the pressure sensor 20. Thus, a variation attributable to the pressure of the intake gas can be eliminated from the provisional O₂ concentration, whereby the error of the corrected O₂ concentration can be reduced. That is, the accuracy of the value representing the oxygen concentration measured by the oxygen sensor 10 can be improved.

The provisional specific-component concentration is computed through use of Expression (1) given below.

$$Provisional {O}_{2} concentration = 1 - {e}^{( - A \cdot {I}_{P} \cdot \frac{B + P}{P} )}$$

Therefore, the accuracy of the value representing the oxygen concentration can be improved as compared with the case where the current value Ipv which is output from the oxygen sensor and represents the oxygen concentration is not corrected. Moreover, although the provisional O₂ concentration computed using Expression (1) contains an error, the error of the O₂ concentration can be decreased by correcting the provisional O₂ concentration using a correction value based on the correction term which is a function of the provisional O₂ concentration and the pressure value P measured by the pressure sensor 20.

The error of the O₂ concentration computed by the ECU 30 can be decreased by using, as the correction term, a polynomial expression associated with the measured pressure value x, as shown by Expressions (9) and (10) or Expressions (9) and (11). For example, even when the dependence of the provisional O₂ concentration on the intake gas pressure changes continuously with the change in intake gas pressure, an increase in the error of the O₂ concentration can be restrained by using, as the correction term, a polynomial selected for said change.

Since each of the coefficients a, b and c (or the coefficients d and e) of the individual terms of the correction term is a function of the provisional O₂ concentration, the error of the O₂ concentration computed by the ECU 30 can be decreased further. For example, in the case where dependence of the provisional O₂ concentration on the pressure of the intake gas changes greatly with the intake gas pressure and the provisional O₂ concentration cannot be corrected satisfactorily through use of the correction term which is a fixed polynomial expression, reducing the error of the O₂ concentration is difficult. Even in such a case, by changing the coefficients a, b and c (or the coefficients d and e) of the individual terms of the polynomial expression in accordance with the provisional O₂ concentration, the range in which the provisional O₂ concentration can be corrected by the correction term can be broadened and the increase in the error of the O₂ concentration can be restrained more reliably.

In the above-described embodiment, Expression (1) is used to compute the provisional O₂ concentration. However, no particular limitation is imposed on the expression used to compute the provisional O₂ concentration. For example, the provisional O₂ concentration may be calculated by use of an expression obtained from the above-described Expression (1) through Taylor expansion of the exponent part “(−A·Ip (B+P)/P)” of Expression (1).

Meanwhile, in the above-described embodiment, the current value Ip of the oxygen sensor 10 is used as the output value thereof. However, no particular limitation is imposed on the output value; for example, a voltage value Vp of the oxygen sensor 10 may be used as the output value.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

This application claims benefit of Japanese Patent Application No. 2011-173073, filed Aug. 8, 2011, incorporated herein by reference in its entirety.

What is claimed is:

1. A gas sensor apparatus comprising:
a gas sensor which outputs an output value corresponding to the concentration of a specific gas component contained in a gas flowing through a flow passage provided in an internal combustion engine;
a pressure sensor which measures the pressure of the gas; and
a computation section which computes a concentration value of the specific gas component on the basis of the output value output from the gas sensor and a pressure value of the gas measured by the pressure sensor, the gas sensor apparatus characterized in that the computation section:
computes a provisional specific-component concentration using an expression which is derived from Fick's law and is a function of the output value output from the gas sensor and the pressure value measured by the pressure sensor,
computes a correction value on the basis of a correction term which is a function of the provisional specific-component concentration and the pressure value measured by the pressure sensor, and
corrects the provisional specific-component concentration using the correction value in order to compute the concentration value of the specific gas component.

2. The gas sensor apparatus as claimed in claim 1, wherein the computation section computes the provisional specific-component concentration using the following expression:
$$Provisional specific \text{-} component concentration = 1 - {e}^{( - A \cdot {I}_{P} \cdot \frac{B + P}{P} )}$$
where Ip represents the output value output from the gas sensor, P represents the pressure value measured by the pressure sensor, and A and B are constants which allow approximation between two provisional specific-component concentrations which are computed from two pressure values and two output values corresponding to the two pressure values.

3. The gas sensor apparatus as claimed in claim 1, wherein the correction term is a polynomial expression associated with the pressure measured by the pressure sensor.

4. The gas sensor apparatus as claimed in claim 3, wherein different coefficients are contained in the individual terms of the polynomial expression, and each of these coefficients is a function of the provisional specific-component concentration.

5. A concentration measurement method using a gas sensor disposed in a flow passage provided in an internal combustion engine which outputs an output value corresponding to the concentration of a specific gas component contained in a gas flowing through the flow passage and a pressure sensor disposed in the flow passage which measures the pressure of the gas, the method being adapted to compute a concentration value of the specific gas component on the basis of the output value output from the gas sensor and a pressure value of the gas measured by the pressure sensor,
the method comprising the steps of:
computing a provisional specific-component concentration using an expression which is derived from Fick's law and which is a function of the output value output from the gas sensor and the pressure value measured by the pressure sensor,
computing a correction value on the basis of a correction term which is a function of the provisional specific-component concentration and the pressure value measured by the pressure sensor, and
correcting the provisional specific-component concentration using the correction value in order to compute the concentration value of the specific gas component.

6. The concentration measurement method as claimed in claim 5, which comprises computing the provisional specific-component concentration using the following expression:
$$Provisional specific \text{-} component concentration = 1 - {e}^{( - A \cdot {I}_{P} \cdot \frac{B + P}{P} )}$$
where Ip represents the output value output from the gas sensor, P represents the pressure value measured by the pressure sensor, and A and B are constants which allow approximation between two provisional specific-component concentrations which are computed from two pressure values and two output values corresponding to the two pressure values.

7. The concentration measurement method as claimed in claim 5, wherein the correction term is a polynomial expression associated with the pressure measured by the pressure sensor.

8. The concentration measurement method as claimed in claim 7, wherein different coefficients are contained in the individual terms of the polynomial expression, and each of these coefficients is a function of the provisional specific-component concentration.
